(19) United States
(12) Patent Application Publication
(10) Pub. No.: US 2026/0280656 A1
(43) Pub. Date: Sep. 17, 2026

(54) CHANNEL STATE INFORMATION MEASUREMENT AND REPORT

(71) Applicant: ZTE Corporation, Shenzhen (CN)

(72) Inventors: Minqiang ZOU, Shenzhen (CN); Bo GAO, Shenzhen (CN); Guangyu JIANG, Shenzhen (CN); Ke YAO, Shenzhen (CN); Wenjun YAN, Shenzhen (CN)

(21) Appl. No.: 19/674,474

(22) Filed: May 12, 2026

Related U.S. Application Data
(63) Continuation of application No. PCT/CN2023/132086, filed on Nov. 16, 2023.

(51) Int. Cl. H04B 7/06; H04W 72/0453

(52) U.S. Cl. CPC H04B 7/0626; H04W 72/0453

(57) ABSTRACT

Methods, apparatus, and systems that relate to techniques that can be implemented to support CSI-RS resource configuration, measurement, and reporting of more than 32 ports transmission. In one example aspect, a method for wireless communication includes transmitting, by a base station, configuration information to a user equipment configuring one or more resources to support more than 32 Channel State Information Reference Signal (CSI-RS) ports, and performing, by the base station, a CSI-RS transmission to the user equipment using the more than 32 CSI-RS ports according to the configuration information.

### CROSS-REFERENCE TO RELATED APPLICATION

This application is a continuation and claims priority to PCT International Application No. PCT/CN2023/132086, filed on Nov. 16, 2023, the disclosure of which is hereby incorporated by reference herein in its entirety.

### TECHNICAL FIELD

This patent document is directed to digital communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques related to techniques that can be implemented to support CSI-RS resource configuration, measurement, and reporting of more than 32 ports transmission.

In one example aspect, a method for wireless communication includes transmitting, by a base station, configuration information to a user equipment configuring one or more resources to support more than 32 Channel State Information Reference Signal (CSI-RS) ports, and performing, by the base station, a CSI-RS transmission to the user equipment using the more than 32 CSI-RS ports according to the configuration information.

In another example aspect, a method for wireless communication includes receiving, by a user equipment, configuration information from a base station configuring one or more resources to support more than 32 Channel State Information Reference Signal (CSI-RS) ports, and receiving, by the user equipment, a CSI-RS transmission from the base station using the more than 32 CSI-RS ports according to the configuration information.

In another example aspect, a communication apparatus is disclosed. The apparatus includes a processor that is configured to implement an above-described method.

In yet another example aspect, a computer-program storage medium is disclosed. The computer-program storage medium includes code stored thereon. The code, when executed by a processor, causes the processor to implement a described method.

These, and other, aspects are described in the present document.

### BRIEF DESCRIPTION OF DRAWINGS

FIG. 1 illustrates a simplified example of multiple-input and multiple-output (MIMO) transmissions.

FIG. 2 illustrates a mathematical representation of the receiver and transmitter relationship.

FIG. 3A is flowchart representation of a method for wireless communication in accordance with one or more embodiments of the present technology.

FIG. 3B is flowchart representation of a method for wireless communication in accordance with one or more embodiments of the present technology.

FIG. 4A is flowchart representation of another method for wireless communication in accordance with one or more embodiments of the present technology.

FIG. 4B is flowchart representation of yet another method for wireless communication in accordance with one or more embodiments of the present technology.

FIG. 5A illustrates an example of a Channel State Information Reference Signal (CSI-RS) resource in accordance with one or more embodiments of the present technology.

FIG. 5B illustrates another example of a CSI-RS resource in accordance with one or more embodiments of the present technology.

FIG. 6 shows an example of a wireless communication system where techniques in accordance with one or more embodiments of the present technology can be applied.

FIG. 7 is a block diagram representation of a portion of a radio station in accordance with one or more embodiments of the present technology can be applied.

### DETAILED DESCRIPTION

Section headings are used in the present document only to improve readability and do not limit scope of the disclosed embodiments and techniques in each section to only that section. Furthermore, some embodiments are described with reference to Third Generation Partnership Project (3GPP) Fifth Generation (5G) New Radio (NR) or Sixth Generation (6G) standard for ease of understanding and the described technology may be implemented in different wireless systems that implement protocols other than the NR or 6G protocol.

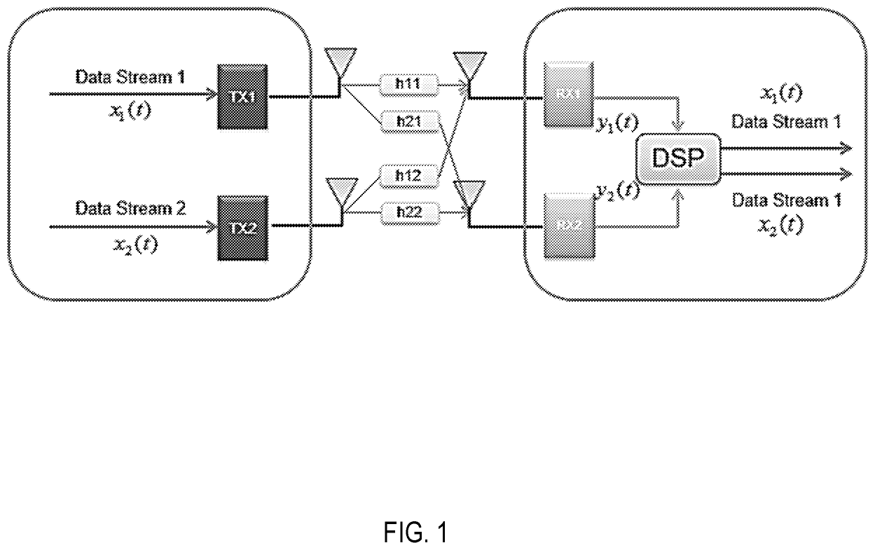

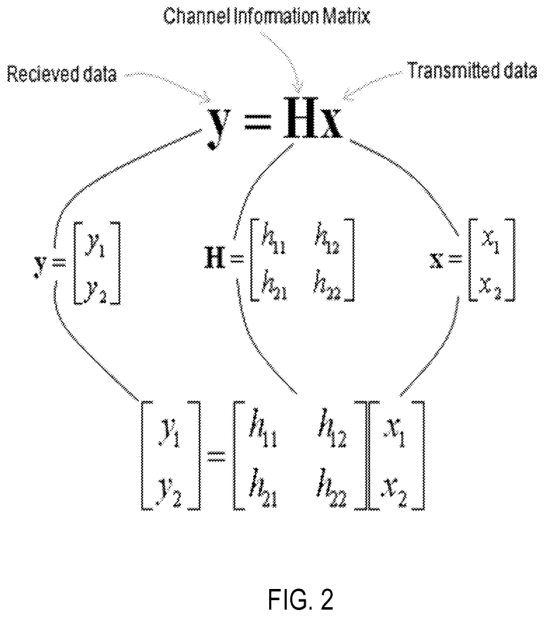

In wireless communication systems, multiple-input and multiple-output (MIMO) is a method for multiplying the capacity of a radio link using multiple transmission and receiving antennas to exploit multipath propagation. FIG. 1 illustrates a simplified example of MIMO transmissions. In case of 2×2, overall data transmission process can be illustrated as follows. The arrows and four blocks (h11, h12, h21, h22) between the two antenna is to illustrate the possible data path between the two Tx and two Rx antenna. FIG. 2 illustrates a mathematical representation of the receiver and transmitter relationship. The algorithm by which a User Equipment (UE) selects the codebook which is best fit for the channel at specific moment is as follows:
Step 1-1: Calculate W (H^{H}H)W^{H} for every element in the codebook.
Step 1-2: Select the codebook element that provides the best match (e.g., the minimum value).
Step 1-3: Report the index of the selected codebook element (e.g., as precoding matrix indicator, PMI) to the base station.

With the development of wireless technology, multiple Channel State Information Reference Signal (CSI-RS) ports are used by the base station to transmit the CSI-RS for a user equipment (UE) to feedback CSI information for MIMO communication. Currently, a transmit-receive point (TRP) can support up to 32 CSI-RS ports. The limitation of 32 CSI-RS ports is largely due to the fact that hardware complexity increases with the number of supported CSI-RS ports. With the advance of MIMO technology, new frequency bands have become available. To provide better coverage and increase spectrum efficiency, a TRP having larger antenna array(s) and more antennas becomes the focus in the industry. With the changes of the hardware, more than 32 CSI-RS ports are needed for CSI-RS measurements and reporting.

This patent document discloses techniques that can be implemented in various embodiments to provide new designs of CSI-RS resource configuration, measurement, and reporting for more than 32 ports transmission. The disclosed techniques provide different configurations of CSI-RS resource(s) to provide support for a large number of CSI-RS ports. The disclosed techniques can also be implemented to account for codebook changes, in both Type I and Type II codebooks, when multiple CSI-RS resources are used to support more than 32 CSI-RS ports.

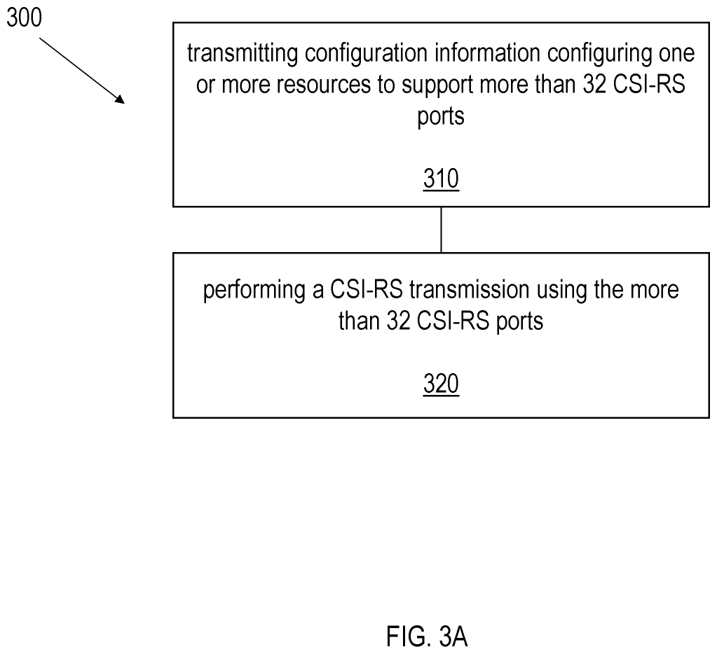

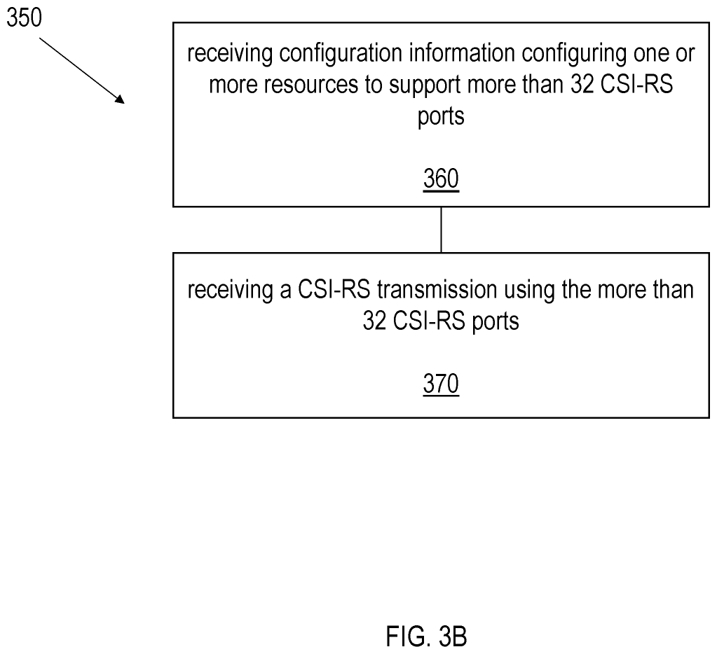

FIG. 3A is a flowchart representation of a method for wireless communication in accordance with one or more embodiments of the present technology. The method 300 includes, at operation 310, transmitting, by a base station, configuration information to a user equipment configuring one or more resources to support more than 32 Channel State Information Reference Signal (CSI-RS) ports. The method 300 includes, at operation 320, performing, by the base station, a CSI-RS transmission to the user equipment using the more than 32 CSI-RS ports according to the configuration information.

FIG. 3B is a flowchart representation of a method for wireless communication in accordance with one or more embodiments of the present technology. The method 350 includes, at operation 360, receiving, by a user equipment, configuration information from a base station configuring one or more resources to support more than 32 Channel State Information Reference Signal (CSI-RS) ports. The method 350 includes, at operation 370, receiving, by the user equipment, a CSI-RS transmission from the base station using the more than 32 CSI-RS ports according to the configuration information.

In some embodiments, the one or more resources comprise multiple resource elements that occupy X number of slots, X being a positive integer. In some embodiments, X is configured by the base station or is based on a capability of the user equipment.

In some embodiments, the one or more resources occupy multiple sub-bands in frequency domain. A first sub-band that corresponds to part of the more than 32 CSI-RS ports is configured with port sharing with a second sub-band that corresponds to all of the more than 32 CSI-RS ports.

In some embodiments, a single resource is configured to support the more than 32 CSI-RS ports. In some embodiments, N resources are configured to support the more than 32 CSI-RS ports, N being a positive integer that is greater than 1. The N resources are configured as a CSI-RS resource set.

In some embodiments, a precoder is determined based on the N resources, with each of the N resources supporting P CSI-RS ports, P being a positive integer. In some embodiments, the precoder is determined based on a basic vector selected from a set of basic vectors, and the basic vector comprises Kx (P/2) rows, K being a positive integer smaller than or equal to N. In some embodiments, the value of K is reported by the UE to the base station.

In some embodiments, the precoder is determined based on K phase coefficients a basic vector selected from a set of basic vectors, K being a positive integer smaller than or equal to N, and the basic vector comprises P/2 rows. In some embodiments, generation of the set of basic vectors is associated with a value of K. In some embodiments, the set of basic vectors comprises horizontal basic vectors and vertical basic vectors. In some embodiments, the horizontal basic vectors are associated with K1 and the vertical basic vectors are associated with K2, and wherein K1 and K2 are based on the value of K. In some embodiments, the user equipment is configured to report (K−1) phase coefficients.

In some embodiments, the precoder is determined based on K basic vectors selected from a set of basic vectors, K being a positive integer smaller than or equal to N, and each of the K basic vectors comprises P/2 rows. In some embodiments, each of the K basic vectors is associated with a resource. In some embodiments, the precoder is further determined based on K amplitude coefficients, K phase coefficients, and K polarization phases. In some embodiments, the K amplitude coefficients are common to the N resources. In some embodiments, the user equipment is configured to omit the K amplitude coefficients in CSI-RS reporting. In some embodiments, the user equipment is configured to report (K−1) phase coefficients.

In some embodiments, one or more spatial domain basic vectors associated with the precoder are common to the N resources. In some embodiments, one or more frequency domain basic vectors associated with the precoder are common to the N resources. In some embodiments, the selected basic vector or the selected K basic vectors are common to all frequency domain units occupied by the one or more resources. In some embodiments, the selected basic vector or the selected K basic vectors are specific to each frequency domain units occupied by the one or more resources.

In some embodiments, a polarization phase is common to all frequency domain units occupied by the one or more resources. In some embodiments, a polarization phase is specific to each frequency domain units occupied by the one or more resources. In some embodiments, a size of a frequency domain unit comprises at least one of: a sub-band, half of a sub-band, two sub-bands, or a wideband.

In some embodiments, a codebook subset restriction (e.g., which subset(s) can be used) is common to all K resources of the N resources. In some embodiments, a codebook subset restriction is specific to each of K resources of the N resources.

In some embodiments, a bitmap for indicating locations of nonzero coefficients is common to the N resources. In some embodiments, a bitmap for indicating locations of nonzero coefficients is specific to each of the N resources. In some embodiments, the precoder comprises a plurality of layers, and wherein a bitmap that indicates locations of nonzero coefficients is common to the plurality of layers. In some embodiments, the precoder comprises a plurality of layers, and a number of bitmaps that indicate locations of nonzero coefficients is based on a number of the plurality of layers.

Details regarding the above techniques are further discussed in the embodiments below.

### Embodiment 1

This embodiment is related to configuring one CSI-RS resource to support more than 32 CSI-RS ports. The number of CSI-RS ports supported by one CSI-RS resource can be 64, 128, 256, 512, 1024, etc.

Currently, a configured CSI-RS can correspond to up to 32 antenna ports. In a multi-port arrangement, multiple orthogonally transmitted per-antenna-port CSI-RS, sharing the overall set of resource elements (REs) assigned for the configured multi-port CSI-RS. Sharing can be based on combinations of: Code Domain Multiplexing (CDM), Frequency Domain Multiplexing (FDM), and/or Time Domain Multiplexing (TDM).

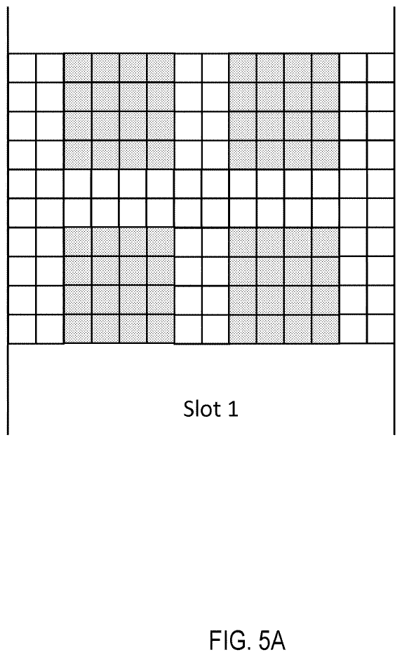

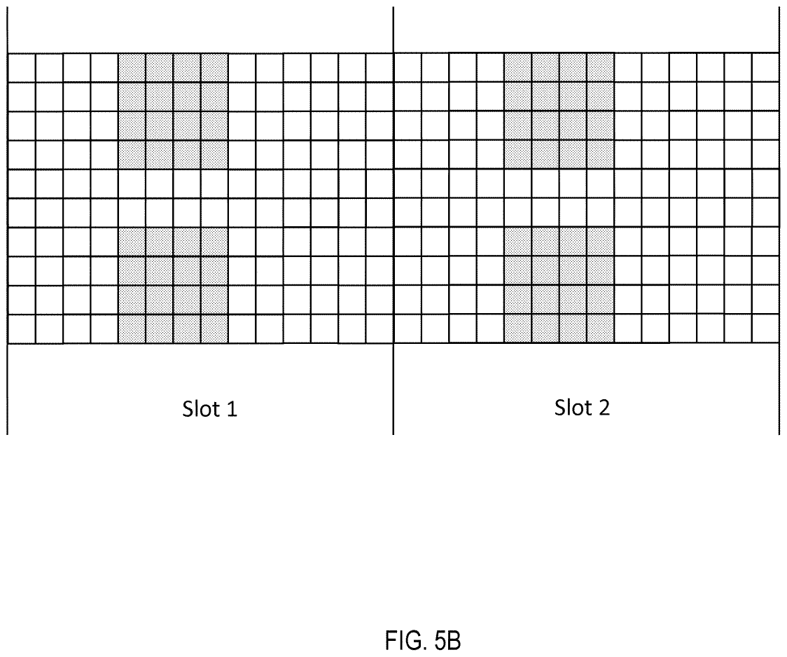

To support more than 32 antenna ports, in some embodiments, one CSI-RS resource includes multiple REs that are configured to be associated with CSI-RS such that a combination of CDM, FDM, and/or TDM techniques can be used. To support a large number of CSI-RS ports, in some embodiments, the multiple resource elements are configured within X slots. The value of X can be configured by higher layer parameters or subject to UE capability. For example, X is a positive integer, and its value can be 1, 2, 3 or so on. FIG. 5A illustrates an example of a CSI-RS resource in accordance with one or more embodiments of the present technology. In this example, X is configured to be 1. The shaded symbols in one slot represent a 64-port CSI-RS resource occupying multiple REs, where CDM, FDM, and/or TDM are used to enable the large number of ports. FIG. 5B illustrates another example of a CSI-RS resource in accordance with one or more embodiments of the present technology. In this example, X is configured to be 2. The shaded symbols represent a 64-port CSI-RS resource occupying multiple REs, where CDM, FDM, and/or TDM are used to enable the large number of ports.

In some embodiments, one CSI-RS resource includes multiple sub-bands. For example, six sub-bands are associated with the CSI-RS resource: Subband-1, Subband-2, . . . , Subband-6, where Subband-1 and Subband-6 are positioned at the edge of the frequency band and Subband-2 to Subband-5 are positioned in the center. In some embodiments, if a sub-band (e.g., Subband-1 at the edge) is not able to cover all the supported ports, the ports can be shared within multiple sub-bands. For example, the ports are shared within M sub-bands, where M is configured by higher layer parameters or subject to UE capability. The value of M can be a positive integer such as 1, 2, 3 or so on.

Table 1 illustrates an example port sharing of multiple sub-bands in accordance with one or more embodiments of the present technology. In this example, a total of 128 CSI-RS ports are supported. As shown in Table 1, the first sub-band (Subband-1) and the last sub-band (Subband-6) associated with the CSI-RS resource can only cover part of the supported ports (e.g., ports 96 to 127, and ports 0 to 63) while the remaining sub-bands can cover all the supported ports. If the value of M is configured to be 1, the part of the CSI-RS resource associated with port index from 0 to 95 in Subband-2 can be shared with Subband-1. Similarly, the part of the CSI-RS resource associated with port index from 64 to 127 in Subband-5 can be shared with Subband-6.

TABLE 1

| | |
|---|---|
| Subband-1 | Port index from 96 to 127 |
| Subband-2 | Port index from 0 to 127 |
| Subband-3 | Port index from 0 to 127 |
| Subband-4 | Port index from 0 to 127 |
| Subband-5 | Port index from 0 to 127 |
| Subband-6 | Port index from 0 to 63 |

### Embodiment 2

This embodiment is related to configuring multiple CSI-RS resources to support more than 32 CSI-RS ports. The number of CSI-RS ports supported by one CSI-RS resource can be 64, 128, 256, 512, 1024, etc. Each of the multiple CSI-RS resources supports up to 32 CSI-RS ports, and a combination of multiple CSI-RS resources can be configured to support more than 32 CSI-RS ports.

In some embodiments, the multiple CSI-RS resources includes multiple REs that are configured within X slots. The value of X can be configured by higher layer parameters or subject to UE capability. For example, X is a positive integer, and its value can be 1, 2, 3 or so on.

In some embodiments, the multiple CSI-RS resources includes multiple sub-bands. For example, six sub-bands are associated with the multiple CSI-RS resources: Subband-1 configured for CSI-RS resource D, Subband-2 configured for CSI-RS resources A-D, . . . , Subband-5 configured for CSI-RS resources A-D, and Subband-6 configured for CSI-RS resources A-B, where Subband-1 and Subband-6 are positioned at the edge of the frequency band and Subband-2 to Subband-5 are positioned in the center. In some embodiments, if a sub-band (e.g., Subband-1 at the edge) is not able to cover all the supported ports, the ports can be shared within multiple sub-bands. For example, the ports are shared within M sub-bands, where M is configured by higher layer parameters or subject to UE capability. The value of M can be a positive integer such as 1, 2, 3 or so on.

Table 2 illustrates another example port sharing of multiple sub-bands in accordance with one or more embodiments of the present technology. In this example, a total of 128 CSI-RS ports are supported by four CSI-RS resources. As shown in Table 2, the first sub-band (Subband-1 configured for CSI-RS resource D) and the last sub-band (Subband-6 configured for CSI-RS resources A-B) can only cover part of the supported ports (e.g., ports 96 to 127, and ports 0 to 63) while the remaining sub-bands can cover all the supported ports. If the value of Mis configured to be 1, the part of the CSI-RS resource associated with port index from 0 to 95 in Subband-2 can be shared with Subband-1. Similarly, the part of the CSI-RS resource associated with port index from 64 to 127 in Subband-5 can be shared with Subband-6.

TABLE 2

| | |
|---|---|
| Subband-1 | Port index from 96 to 127 (CSI-RS D) |
| Subband-2 | Port index from 0 to 127 (CSI-RS A-D) |
| Subband-3 | Port index from 0 to 127 (CSI-RS A-D) |
| Subband-4 | Port index from 0 to 127 (CSI-RS A-D) |
| Subband-5 | Port index from 0 to 127 (CSI-RS A-D) |
| Subband-6 | Port index from 0 to 63 (CSI-RS A-B) |

In some embodiments, a method for wireless communication comprises transmitting, by a base station, configuration information (e.g., Radio Resource Control, RRC, configuration) to a user equipment configuring multiple resources to be used for a CSI-RS transmission to support more than 32 ports. In some embodiments, the multiple resources are organized in a CSI-RS resource set.

In some embodiments, a method for wireless communication comprises receiving, by a user equipment, configuration information (e.g., RRC configuration) from a base station configuring multiple resources to be used for a CSI-RS transmission to support more than 32 ports. In some embodiments, the multiple resources are organized in a CSI-RS resource set.

When multiple CSI-RS resources are configured to allow the use of more than 32 CSI-RS ports, the precoder needs to be adapted to account for the effect of multiple CSI-RS resources so as to ensure that the reported CSI is accurate. For example, quantities used to determine the precoder (e.g., basic vector(s), phase coefficients, and/or amplitude coefficients) are adjusted based on the number of the CSI-RS resources.

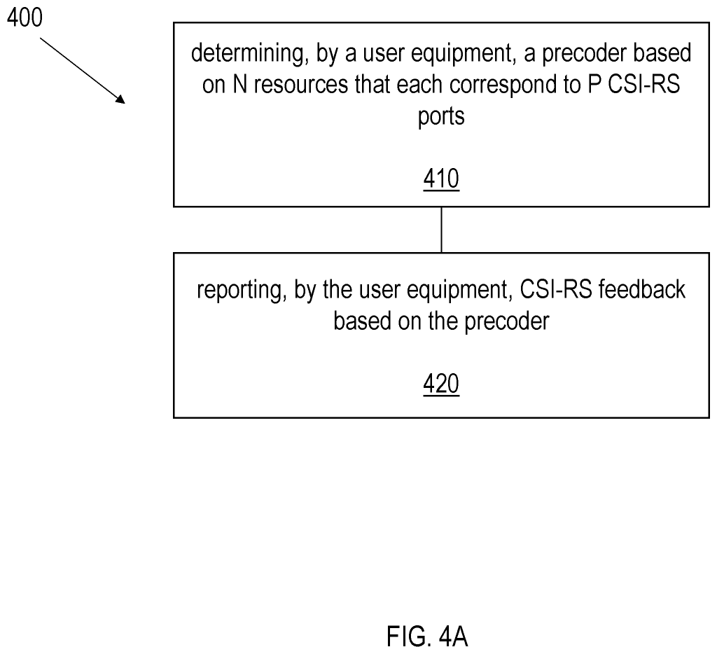

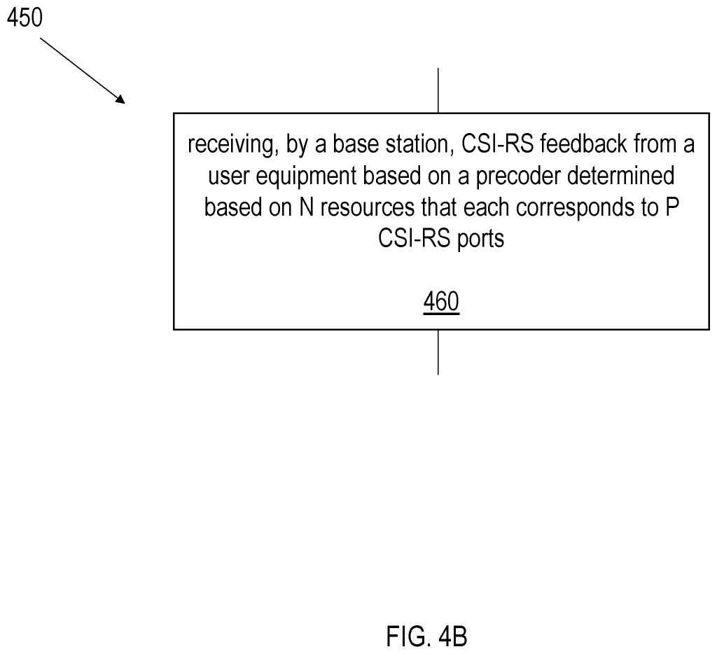

FIG. 4A is a flowchart representation of a method for wireless communication in accordance with one or more embodiments of the present technology. The method 400 includes, at operation 410, determining, by a user equipment, a precoder based on N resources that each corresponds to P CSI-RS ports, where N and P are positive integers. The precoder is determined for the multiple resources so that the total number of CSI-RS ports is greater than 32. The method also includes, at operation 420, reporting, by the user equipment, CSI-RS feedback based on the precoder.

FIG. 4B is a flowchart representation of a method for wireless communication in accordance with one or more embodiments of the present technology. The method 450 includes, at operation 460, receiving, by a base station, CSI-RS feedback from a user equipment based on a precoder determined based on N resources that each corresponds to P CSI-RS ports, where N and P are positive integers.

In some embodiments, the precoder is determined based on a basic vector having Kx (P/2) rows, where 1<K<=N. In some embodiments, the precoder is determined based on K basic vectors each having P/2 rows. The basic vector(s) can be applicable to Type I codebooks and/or Type II codebooks (e.g., as spatial domain basic vector(s)). In some embodiments, the precoder is determined based on K phase coefficients. In some embodiments, the precoder is determined based on K amplitude coefficients. The value of K can be associated with the value of N, be configured by the base station, and/or based on UE capability. In some embodiments, the value of K is reported by the UE to the base station.

### Embodiment 3

This embodiment is related to example precoder changes when multiple CSI-RS resources are configured to support more than 32 CSI-RS ports, particularly for Type I codebooks. In some embodiments, the precoder is determined based on N CSI-RS resources, each CSI-RS resource contain P CSI-RS ports, P being a positive integer, and the N CSI-RS resources are configured into a CSI-RS resource set. The precoder is determined based on a Discrete Fourier Transform (DFT) basic vector and a polarization phase. The DFT basic vector includes Kx (P/2) rows and 1 column. In some embodiments, 1<K<=N. The value of K can be configured by higher layer parameters or reported by UE. In some embodiments, the DFT basic vector is selected from a DFT basic vector set.

For example, the precoder can be denoted as W=[v₁]. Alternatively, or in addition, the precoder is denoted as

$$W = [ {v}_{1} {e}^{j {θ}_{1}} ] ,$$

where v₁ represents the selected DFT basic vector and θ₁ represents the polarization phase.

In some embodiments, the selected DFT basic vector is common for all frequency domain units. In some embodiments, the selected DFT basic vector is specific for each frequency domain unit. In some embodiments, the polarization phase is common for all frequency domain units. In some embodiments, the polarization phase is specific for one or each of frequency domain units. The size of frequency domain unit can be configured by higher layer parameters. For example, the size of the frequency domain unit can be a sub-band, half a sub-band, two sub-bands, or a wideband.

### Embodiment 4

This embodiment is related to example precoder changes when multiple CSI-RS resources are configured to support more than 32 CSI-RS ports, particularly for Type I codebooks.

In some embodiments, the precoder is based on one DFT basic vector and K phase coefficients. The DFT basic vector includes P/2 rows and 1 column. Each of the K phase coefficients is associated with a CSI-RS resource. For example, the precoder for rank=1 can be denoted as:

$$W = [ \begin{matrix}{e}^{j {ϕ}_{1}} {v}_{1} \\ {e}^{j {ϕ}_{2}} {v}_{1} \\ ⋮ \\ {e}^{j {ϕ}_{K}} {v}_{1}\end{matrix} ]$$

The precoder for rank>1 can be denoted as follows, where rank is equal to R:

$$W = [ \begin{matrix}{e}^{j {ϕ}_{1}} {v}_{1} & … & {A}_{1} {e}^{j {ϕ}_{1}} {v}_{R} \\ {e}^{j {ϕ}_{2}} {v}_{1} & … & {A}_{2} {e}^{j {ϕ}_{2}} {v}_{R} \\ ⋮ & & \\ {e}^{j {ϕ}_{K}} {v}_{1} & … & {A}_{K} {e}^{j {ϕ}_{K}} {v}_{R}\end{matrix} ]$$

Different columns of W are orthogonal to each other. To achieve orthogonality, A₁, A₂, . . . and A_{K} can be equal to 1 or −1. In some embodiments, vᵢ is common to all ranks (e.g., v_{R}= . . . =v₁). In some embodiments, vᵢ can be different for different ranks (e.g., v_{R}!=v₁).

In some embodiments, quantities uₘ, v_{l,m}, and \tilde{v}_{l,m} for determining the codebooks can be represented in the following forms. For example, v_{l,m} can be given by

$${v}_{l , m} = [ \begin{matrix}{u}_{m} & {e}^{j \frac{2 π l}{{O}_{1} {N}_{1} / K}} {u}_{m} & … & {e}^{j \frac{2 π l ( {N}_{1} / K - 1 )}{{O}_{1} {N}_{1} / K}} {u}_{m}\end{matrix} ] .$$

In some embodiments, \tilde{v}_{l,m} can be denoted as

$${\tilde{v}}_{l , m} = [ \begin{matrix}{u}_{m} & {e}^{j \frac{2 π l}{{O}_{1} {N}_{1} / K}} {u}_{m} & … & {e}^{j \frac{2 π l ( {N}_{1} / K - 1 )}{{O}_{1} {N}_{1} / K}} {u}_{m}\end{matrix} ] .$$

In some embodiments, uₘ can be denoted as

$${u}_{m} = \{ \begin{matrix}[ \begin{matrix}1 & {e}^{j \frac{2 π m}{{O}_{2} {N}_{2} / K}} & … & {e}^{j \frac{2 π m ( {N}_{2} / K - 1 )}{{O}_{2} {N}_{2} / K}}\end{matrix} ] & {N}_{2} > 1 \\ 1 & {N}_{2} = 1\end{matrix}$$

In some embodiments, K phase coefficients can be considered as comprising parts K1 and K2 in different polarization directions (e.g., horizontal and vertical). For example, C=K1×K2. In some embodiments, K1 and K2 can be configured by higher layer parameters or subject to UE capability. For example, K1, K2=1,2,3 and so on. uₘ and [symbol] can be denoted as:

$${u}_{m} = \{ \begin{matrix}[ \begin{matrix}1 & {e}^{j \frac{2 π m}{{O}_{2} {N}_{2} / K}} & … & {e}^{j \frac{2 π m ( {N}_{2} / K - 1 )}{{O}_{2} {N}_{2} / K}}\end{matrix} ] & {N}_{2} > 1 \\ 1 & {N}_{2} = 1\end{matrix}$$

$${\tilde{v}}_{l , m} = [ \begin{matrix}{u}_{m} & {e}^{j \frac{2 π l}{{O}_{1} {N}_{1} / K}} {u}_{m} & … & {e}^{j \frac{2 π l ( {N}_{1} / K - 1 )}{{O}_{1} {N}_{1} / K}} {u}_{m}\end{matrix} ]$$

In some embodiments, phase differential information is reported. To reduce signaling overhead, the first phase coefficient is not reported by the UE. The remain K−1 differential phase values are reported. For example, the first phase coefficient φ₁ is not reported (e.g., assigned to be 0 or a default value). The second phase coefficient is φ₂−φ₁, and the K-th phase coefficient φ_{K}−φ₁.

In some embodiments, 1<K<=N. The value of K can be configured by higher layer parameters or reported by UE. In some embodiments, the DFT basic vector is selected from a DFT basic vector set. In some embodiments, the selected DFT basic vector is common for all frequency domain unit. In some embodiments, the selected DFT basic vector is specific for each frequency domain unit. In some embodiments, the polarization phase is common for all frequency domain unit. In some embodiments, the polarization phase is specific for one or each of frequency domain units. The size of frequency domain unit can be configured by higher layer parameters. For example, the frequency domain unit can be a sub-band, half a sub-band, two sub-bands, or wideband.

### Embodiment 5

This embodiment is related to example precoder changes when multiple CSI-RS resources are configured to support more than 32 CSI-RS ports, particularly for Type I codebooks.

In some embodiments, the precoder is computed by N CSI-RS resources, each CSI-RS resource contain P CSI-RS ports, and the N CSI-RS resources are configured into a CSI-RS resource set. The precoder is determined based on K DFT basic vectors, a plurality of polarization phase, and a plurality of coefficients (e.g., amplitude coefficients and phase coefficients). Each of the K DFT basic vectors includes P/2 rows and 1 column.

In some embodiments, the K DFT basic vectors are selected from a DFT basic vector set. In some embodiments, 1<K<=N. The value of K can be configured by higher layer parameters or reported by UE. Each of the K DFT basic vectors is associated with a CSI-RS resource.

In some embodiments, a codebook subset restriction is configured by higher layer parameters. For example, a bitmap in the higher layer parameters can be used to configure the codebook subset restriction, indicating which codebook subset(s) can be used for the transmission. In some embodiments, the codebook subset restriction is common to the N CSI-RS resources. In some embodiments, the codebook subset restriction is specific to one of or each of the N CSI-RS resources.

For example, when K=4 and rank=1, the precoder is denoted as:

$$W = [ \begin{matrix}{A}_{1} {e}^{j {ϕ}_{1}} {v}_{1} \\ {A}_{2} {e}^{j {ϕ}_{2}} {v}_{2} \\ ⋮ \\ {A}_{K} {e}^{j {ϕ}_{K}} {v}_{K}\end{matrix} ]$$

As another example, when K=4 and rank=4, the precoder is denoted as:

$$W = [ \begin{matrix}{A}_{1} {e}^{j {ϕ}_{1}} {v}_{1} & {A}_{1} {e}^{j {ϕ}_{1}} {v}_{2} & {A}_{1} {e}^{j {ϕ}_{1}} {v}_{3} & {A}_{1} {e}^{j {ϕ}_{1}} {v}_{4} \\ {A}_{2} {e}^{j {ϕ}_{2}} {v}_{2} & {A}_{2} {e}^{j {ϕ}_{2}} {v}_{3} & {A}_{2} {e}^{j {ϕ}_{2}} {v}_{4} & {A}_{2} {e}^{j {ϕ}_{2}} {v}_{1} \\ {A}_{3} {e}^{j {ϕ}_{3}} {v}_{3} & {A}_{3} {e}^{j {ϕ}_{3}} {v}_{4} & {A}_{3} {e}^{j {ϕ}_{3}} {v}_{1} & {A}_{3} {e}^{j {ϕ}_{3}} {v}_{2} \\ {A}_{4} {e}^{j {ϕ}_{4}} {v}_{4} & {A}_{4} {e}^{j {ϕ}_{4}} {v}_{1} & {A}_{4} {e}^{j {ϕ}_{4}} {v}_{2} & {A}_{4} {e}^{j {ϕ}_{4}} {v}_{3}\end{matrix} ]$$

For another polarization phase and frequency domain, the precoder can be denoted as:

$$W = [ \begin{matrix}{A}_{1} {e}^{j {ϕ}_{1}} {v}_{1} {e}^{j {θ}_{1}} \\ {A}_{2} {e}^{j {ϕ}_{2}} {v}_{2} {e}^{j {θ}_{2}} \\ ⋮ \\ {A}_{K} {e}^{j {ϕ}_{K}} {v}_{K} {e}^{j {θ}_{K}}\end{matrix} ]$$

In the above example precoders, A₁, . . . , A_{K} are the amplitude coefficients, φ₁, . . . , φ_{K} are the phase coefficients, v₁, . . . , v_{K} are the selected DFT basic vectors, and θ₁, . . . , θ_{K} are the polarization phases.

In some embodiments, the K amplitude coefficients are common to the N CSI-RS resources. In such cases, the K amplitude coefficients are omitted in the CSI-RS reporting to reduce signaling overhead.

In some embodiments, the K amplitude coefficients are specific to one or each of the N CSI-RS resources. In such cases, the maximal amplitude coefficient Aₘₐₓ can be used for normalization Aₘₐₓ=max {A₁, . . . , A_{K}}. For example, Aₘₐₓ=A₂, the first amplitude coefficient become A₁/A₂, the second amplitude coefficient become A₁/A₂, and the K-th amplitude coefficient become A_{K}/A₂.

In some embodiments, phase differential information is reported. To reduce signaling overhead, the first phase coefficient is not reported by the UE. The remain K−1 differential phase values are reported. For example, the first phase coefficient φ₁ is not reported (e.g., assigned to be 0 or a default value). The second phase coefficient is φ₂−φ₁, and the K-th phase coefficient φ_{K}−φ₁.

In some embodiments, the K selected DFT basic vectors are common for all frequency domain unit. In some embodiments, the K selected DFT basic vectors are specific for each frequency domain unit. In some embodiments, the K polarization phases are common for all frequency domain unit. In some embodiments, the K polarization phases are specific for frequency domain unit. The size of frequency domain unit can be configured by higher layer parameters. For example, the frequency domain unit can be a sub-band, half a sub-band, two sub-bands, or wideband.

### Embodiment 6

This embodiment is related to example precoder changes when multiple CSI-RS resources are configured to support more than 32 CSI-RS ports, particularly for Type II codebooks.

In some embodiments, the precoder is determined based on N CSI-RS resources, each CSI-RS resource contain P CSI-RS ports, and the N CSI-RS resources are configured into a CSI-RS resource set. The precoder is determined based on L spatial domain (SD) DFT basic vectors, M frequency domain (FD) basic vectors, and a coefficient matrix. L and M are positive integers. Each of the SD basic vector includes Kx (P/2) rows and 1 column. In some embodiments, 1<K<=N. The value of K can be configured by higher layer parameters or reported by UE. In some embodiments, the L SD DFT basic vectors are selected from a DFT basic vector set.

For example, the precoder can be denoted as W=W₁W₂(W_{f})_{H}, where W₁ comprises L SD basis vectors, W_{f} comprises M FD basis vectors. W₂ represents the coefficients matrix that includes nonzero coefficients and zero coefficients.

In some embodiments, a bitmap is used to indicate locations of nonzero coefficients. In some embodiments, one bitmap is common to all layers. In some embodiments, one bitmap common for half of layers. For example, two bitmaps are configured when rank>2 (e.g., the layers are split into two groups, each corresponding to a bitmap). In some embodiments, each layer has a respective bitmap for indicating the location of nonzero coefficients (e.g., a bitmap is applicable to rank=2).

In some embodiments, W₁ for indicating SD basis vector is common for half of layers. For example, two W₁ are configured when rank>2 (e.g., the layers are split into two groups, each corresponding to a W₁).

### Embodiment 7

This embodiment is related to example precoder changes when multiple CSI-RS resources are configured to support more than 32 CSI-RS ports, particularly for Type II codebooks.

In some embodiments, the precoder is determined based on N CSI-RS resources, each CSI-RS resource contain P CSI-RS ports, and the N CSI-RS resources are configured into a CSI-RS resource set. The precoder is determined based on L spatial domain (SD) DFT basic vectors, M frequency domain (FD) basic vectors, and a coefficient matrix.

For example, the precoder can be denoted as

$$W = [ \begin{matrix}{W}_{1 , 1} {{W}_{2 , 1} ( {W}_{f , 1} )}^{H} \\ {W}_{1 , 2} {{W}_{2 , 2} ( {W}_{f , 2} )}^{H} \\ ⋮ \\ {W}_{1 , N} {{W}_{2 , N} ( {W}_{f , N} )}^{H}\end{matrix} ]$$

Here, W_{1,1}, W_{1,2}, . . . , or W_{1,N} comprises L SD basis vectors, W_{f,1}, W_{f,2}, . . . , or W_{f,N} comprises M FD basis vectors, where L and M are integers. W_{2,1}, W_{2,2}, . . . or W_{2,N} represents the coefficients matrix that includes nonzero coefficients and zero coefficients.

In some embodiments, for each layer, W_{1,1}, W_{1,2}, . . . and W_{1,N} are common for the N CSI-RS resources, W_{f,1}, W_{f,2}, . . . and W_{f,N} are common for the N CSI-RS resources, and the bitmap for indicating the locations of nonzero coefficients is common for the N CSI-RS resources.

In some embodiments, for each layer, W_{1,1}, W_{1,2}, . . . and W_{1,N} are common for the N CSI-RS resources and W_{f,1}, W_{f,2}, . . . and W_{f,N} are common for the N CSI-RS resources. The bitmap for indicating the location of nonzero coefficients is specific to one or each of the N CSI-RS resources.

In some embodiments, for each layer, W_{1,1}, W_{1,2}, . . . and W_{1,N} are common for the N CSI-RS resources and the bitmap for indicating the locations of nonzero coefficients is common for the N CSI-RS resources. W_{f,1}, W_{f,2}, . . . and W_{f,N} are specific to one or each of the N CSI-RS resources.

In some embodiments, a bitmap is used to indicate locations of nonzero coefficients. In some embodiments, one bitmap is common to all layers. In some embodiments, one bitmap common for half of layers. For example, two bitmaps are configured when rank>2 (e.g., the layers are split into two groups, each corresponding to a bitmap). In some embodiments, each layer has a respective bitmap for indicating the location of nonzero coefficients (e.g., a bitmap is applicable to rank=2).

In some embodiments, a codebook subset restriction (e.g., which subset(s) can be used) is common to all K resources of the N resources. In some embodiments, a codebook subset restriction is specific to each of K resources of the N resources.

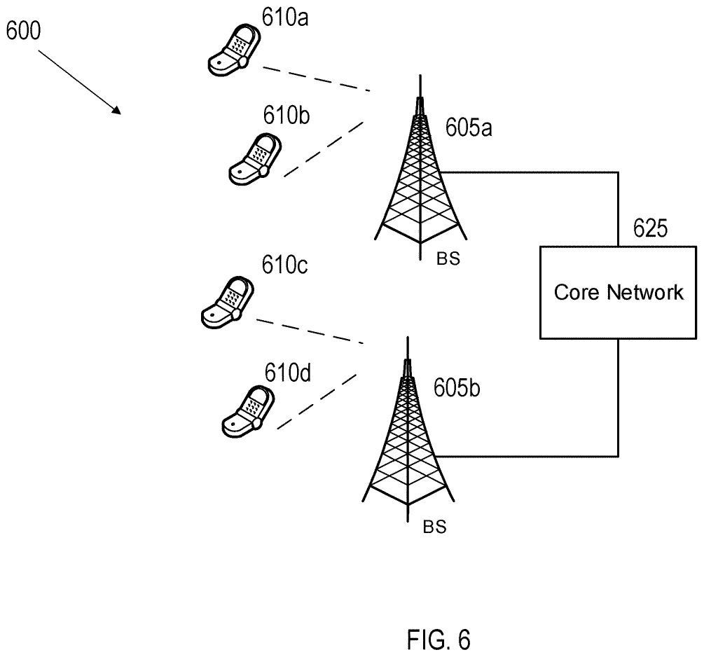

FIG. 6 shows an example of a wireless communication system 600 where techniques in accordance with one or more embodiments of the present technology can be applied. A wireless communication system 600 can include one or more base stations (BSs) 605a, 605b, one or more wireless devices (or UEs) 610a, 610b, 610c, 610d, and a core network 625. A base station 605a, 605b can provide wireless service to user devices 610a, 610b, 610c and 610d in one or more wireless sectors. In some implementations, a base station 605a, 605b includes directional antennas to produce two or more directional beams to provide wireless coverage in different sectors. The core network 625 can communicate with one or more base stations 605a, 605b. The core network 625 provides connectivity with other wireless communication systems and wired communication systems. The core network may include one or more service subscription databases to store information related to the subscribed user devices 610a, 610b, 610c, and 610d. A first base station 605a can provide wireless service based on a first radio access technology, whereas a second base station 605b can provide wireless service based on a second radio access technology. The base stations 605a and 605b may be co-located or may be separately installed in the field according to the deployment scenario. The user devices 610a, 610b, 610c, and 610d can support multiple different radio access technologies. The techniques and embodiments described in the present document may be implemented by the base stations of wireless devices described in the present document.

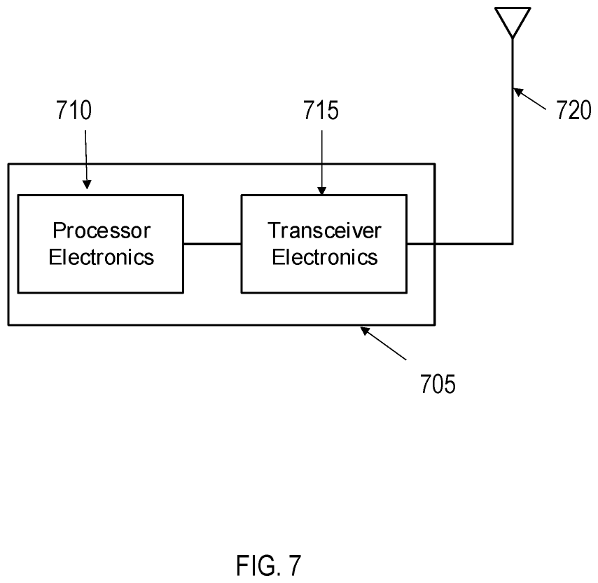

FIG. 7 is a block diagram representation of a portion of a radio station in accordance with one or more embodiments of the present technology can be applied. A radio station 705 such as a network node, a base station, or a wireless device (or a user device, UE) can include processor electronics 710 such as a microprocessor that implements one or more of the wireless techniques presented in this document. The radio station 705 can include transceiver electronics 715 to send and/or receive wireless signals over one or more communication interfaces such as antenna 720. The radio station 705 can include other communication interfaces for transmitting and receiving data. Radio station 705 can include one or more memories (not explicitly shown) configured to store information such as data and/or instructions. In some implementations, the processor electronics 710 can include at least a portion of the transceiver electronics 715. In some embodiments, at least some of the disclosed techniques, modules or functions are implemented using the radio station 705. In some embodiments, the radio station 705 may be configured to perform the methods described herein.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method for wireless communication, comprising:
receiving, by a user equipment, configuration information from a base station configuring one or more resources to support more than 32 Channel State Information Reference Signal (CSI-RS) ports; and
receiving, by the user equipment, a CSI-RS transmission from the base station using the more than 32 CSI-RS ports according to the configuration information.

2. The method of claim 1, wherein the one or more resources comprise multiple resource elements that occupy X number of slots, X being a positive integer, and wherein X is configured by the base station or is based on a capability of the user equipment.

3. The method of claim 1, further including determining a precoder based on K basic vectors selected from a set of basic vectors, K being a positive integer less than or equal to N, wherein N represents a number of resources supporting the more than 32 CSI-RS ports, N being a positive integer greater than 1, wherein each of the K basic vectors comprises P/2 rows, wherein P represents a number of CSI-RS ports, P being a positive integer, and wherein each of the K basic vectors corresponds to a respective one of the N resources.

4. The method of claim 3, wherein the precoder is further determined based on K amplitude coefficients, K phase coefficients, or K polarization phases, K being a positive integer less than or equal to N.

5. The method of claim 4, further including, reporting, by the user equipment, (K−1) phase coefficients.

6. The method of claim 3, wherein the selected K basic vectors are common to all frequency domain units occupied by the one or more resources.

7. The method of claim 4, wherein the polarization phases are common to all frequency units or specific to each frequency domain unit occupied by the one or more resources.

8. The method of claim 7, wherein a size of a frequency domain unit comprises at least one of: a sub-band, half of a sub-band, two sub-bands, or a wideband.

9. The method of claim 3, wherein a codebook subset restriction is common to all K resources of the N resources or is specific to each of the K resources of the N resources.

10. A method for wireless communication, comprising:
transmitting, by a base station, configuration information to a user equipment configuring one or more resources to support more than 32 Channel State Information Reference Signal (CSI-RS) ports; and
performing, by the base station, a CSI-RS transmission to the user equipment using the more than 32 CSI-RS ports according to the configuration information.

11. The method of claim 10, wherein the one or more resources comprise multiple resource elements that occupy X number of slots, X being a positive integer, and wherein X is configured by the base station or is based on a capability of the user equipment.

12. The method of claim 10, further including determining a precoder based on K basic vectors selected from a set of basic vectors, K being a positive integer less than or equal to N, wherein N represents a number of resources supporting the more than 32 CSI-RS ports, N being a positive integer greater than 1, wherein each of the K basic vectors comprises P/2 rows, wherein P represents a number of CSI-RS ports, P being a positive integer, and wherein each of the K basic vectors corresponds to a respective one of the N resources.

13. The method of claim 12, wherein the precoder is further determined based on K amplitude coefficients, K phase coefficients, or K polarization phases, K being a positive integer less than or equal to N.

14. The method of claim 13, further including, reporting, by the user equipment, (K−1) phase coefficients.

15. The method of claim 12, wherein the selected K basic vectors are common to all frequency domain units occupied by the one or more resources.

16. The method of claim 13, wherein the polarization phases are common to all frequency units or specific to each frequency domain unit occupied by the one or more resources.

17. The method of claim 16, wherein a size of a frequency domain unit comprises at least one of: a sub-band, half of a sub-band, two sub-bands, or a wideband.

18. The method of claim 12, wherein a codebook subset restriction is common to all K resources of the N resources or is specific to each of the K resources of the N resources.

19. An apparatus for wireless communication, comprising: processor electronics configured to implement a method, the processor electronics configured to:
receive, by a user equipment, configuration information from a base station configuring one or more resources to support more than 32 Channel State Information Reference Signal (CSI-RS) ports; and
receive, by the user equipment, a CSI-RS transmission from the base station using the more than 32 CSI-RS ports according to the configuration information.

20. An apparatus for wireless communication, comprising: processor electronics configured to implement a method, the processor electronics configured to:
transmit, by a base station, configuration information to a user equipment configuring one or more resources to support more than 32 Channel State Information Reference Signal (CSI-RS) ports; and
perform, by the base station, a CSI-RS transmission to the user equipment using the more than 32 CSI-RS ports according to the configuration information.
